(19) United States
(12) Patent Application Publication
(10) Pub. No.: US 2019/0019598 A1
(43) Pub. Date: Jan. 17, 2019

(54) BIODEGRADABLE FLUIDS FOR HIGH VOLTAGE CABLES

(71) Applicant: M&I Materials Limited, Manchester (GB)

(72) Inventors: Russell MARTIN, Manchester (GB); Francine Edwards, Manchester (GB); Barry Menzies, Manchester (GB)

(21) Appl. No.: 16/035,472

(22) Filed: Jul. 13, 2018

(30) Foreign Application Priority Data
Jul. 13, 2017 (GB) 1711304.4

(51) Int. Cl. H01B 3/42; H01B 9/06

(52) U.S. Cl. CPC H01B 3/421; C08L 2203/202; H01B 9/0688

(57) ABSTRACT

The present invention relates to electrical cables, particularly high voltage cables, comprising a biodegradable fluid to act as an electrical insulating material. The electrical cables may be located overground, in subterranean environments, or under waterways.

### CROSS-REFERENCE TO RELATED APPLICATIONS

This application claims priority to UK Application No. 1711304.4, filed Jul. 13, 2017, titled Biodegradable Fluids for High Voltage Cables, the entire disclosure of which is incorporated herein by reference.

The present invention relates to electrical cables, particularly high voltage cables, comprising a biodegradable fluid to act as an electrical insulating material. The electrical cables may be located overground, in subterranean environments, or under waterways, which can include rivers, lakes, canals, seas and oceans.

High voltage cables are used for the transmission of electric power at high voltage, and are located either overground, underground or underwater. High voltage cables include a conductive element and an insulating element. In some types of cable, the insulating element comprises a mineral oil material.

There are a number of different types of high voltage cables which use the mineral oil insulating element, including paper-insulated oil-filled power cables, high pressure pipe-type cables, and oil-filled submarine cables. Cables which employ a mineral oil as an insulating material are typically located underground or in subsea environments. For example, in the paper-insulated oil-filled power cables, the paper is saturated in the mineral oil and surrounds the high voltage cable; and in the high-pressure pipe-type cables, cable itself is contained within a pipe, leaving a void between the cable and the inside of the pipe, and the mineral oil is pumped under pressure (at about 40 psi) through the pipe along the void, thus surrounding the cable.

However, the cables can be prone to leakage, such that the mineral oil can escape into the surrounding environment. If the mineral oil leaks from an underwater pipe, as the oil is non-biodegradable, then it will inevitably lead to contamination of the waterway the pipe lies beneath. Instances of this nature have occurred, causing environmental damage to the wildlife and vegetation, necessitating expensive operations to clean it up. Corresponding problems arise with leaks in underground or overground pipes. Such contaminations are clearly undesirable.

It would therefore be desirable to be able to use an insulating fluid with high voltage cables which is able to provide the required level of electrical insulation for high voltage cables, and which also does not pose such a threat to the environment in the event of a leak.

Therefore, in accordance with a first aspect of the invention, there is provided an electrical cable comprising a biodegradable fluid, to provide electrical insulation thereto.

The present invention is not concerned with cable connectors.

The electrical cables of the invention are typically cables which carry a high voltage. By ‘high voltage’ is meant herein a voltage of up to about 400 kV.

By ‘biodegradable fluid’ is meant herein a fluid which is considered to be “readily biodegradable” as determined by the internationally recognised OECD 301 biodegradability tests.

The biodegradable fluid may be a dielectric fluid, including both natural and/or synthetic dielectric fluids, more typically synthetic esters. According to one embodiment of the invention, the biodegradable fluid comprises one or more ester compositions. The biodegradable fluid is also substantially non-toxic to the environment, marine life and plant life.

According to a further aspect of the invention, the one or more ester compositions (I) may comprise a plurality of esters derived from a reaction of:
i) one or more polyols, wherein the one or more polyols are each independently a straight chain or branched C₂-C₈ polyol; and
ii) first, second and third carboxylic acids, wherein the first, second and third carboxylic acids are each independently a straight chain or branched C₄-C₁₂ carboxylic acid.

According to one embodiment of the invention, each of the one or more polyols may be a C₂, C₃, C₄, C₅, C₆, C₇, or C₈ polyol. Typically, each of the one or more polyols is selected from straight or branched C₂ to C₅ polyols, and may have a C₂ to C₃ backbone, with or without one or more hydrocarbon side groups. Where any of the polyols are branched, they typically have one or more C₁ or C₂ side groups, typically C₁. Typically, a branched C₅ polyol is used.

By way of non-limiting examples, the polyol may be selected from pentaerythritol, neopentyl glycol (NPG), glycerol, butane diol, ethylene glycol and propylene glycol. More typically, only one polyol is used; the polyol typically comprises one of pentaerythritol or NPG, more typically the polyol comprises pentaerythritol, or the polyol consists of pentaerythritol only.

According to another embodiment, the first, second and third carboxylic acids are typically each independently selected from straight chain or branched C₄, C₅, C₆, C₇, C₈, C₉, C₁₀, C₁₁ and C₁₂ carboxylic acids. According to one embodiment of the invention, the polyol may react with one or more further carboxylic acids which is or are different to the first, second and third carboxylic acids. Alternatively, according to another embodiment of the invention only the first, second and third carboxylic acids are used.

According to one embodiment, the first carboxylic acid is a C₇, C₈, or C₉ carboxylic acid. The first acid may be a C₈ acid, such as a branched C₈ acid. The first acid may have a C₆ backbone and a side group, which may be a C₂ side group, which may be located at the C2-position. The first acid may be, for example, 2-ethylhexanoic acid (2EHA).

According to one embodiment, the second carboxylic acid is a straight chain or branched C₆, C₇, or C₈ carboxylic acid, such as a C₇ acid, still more typically a straight chain linear C₇ acid, i.e. n-heptanoic acid.

According to one embodiment, the third carboxylic acid is a straight chain or branched C₈, C₉, or C₁₀ carboxylic acid, such as a C₉ acid, still more typically a straight chain linear C₉ acid, i.e. n-nonanoic acid.

According to one embodiment, the ester composition (I) comprises esters formed from the reactions of a polyol with (i) a branched C₈ carboxylic acid as the first carboxylic acid; (ii) a linear C₇ carboxylic acid as the second carboxylic acid and (iii) a linear C₉ carboxylic acid as the third carboxylic acid.

According to one embodiment, the polyol comprises or consists of pentaerythritol, the first carboxylic acid is 2EHA, the second carboxylic acid is n-heptanoic acid and the third carboxylic acid is n-nonanoic acid.

The resulting product from this reaction of one or more polyols and three carboxylic acids is not a pure substance and comprises a mixture of a number of possible ester structures. This ester mixture arises as a natural consequence of the reaction process. For example, pentaerythritol contains four alcohol functional groups, so the reaction of pentaerythritol with three acids (such as 2EHA, a C₇ acid and a C₉ acid) would result in many different tetra-ester structures containing different combinations of the functional groups from the three different acids.

The ester composition (I) may comprise small amounts of unreacted alcohol and/or acids as impurities. Typically, the ester composition is substantially free of alcohol and/or acids.

The ester composition (I) typically has a viscosity of 35 cP or less when measured using a Brookfield DV-I Prime Viscometer at 40° C.; more typically it has a viscosity of 33 cP or less at 40° C.; more typically it has a viscosity of 30 cP or less at 40° C.; still more typically it has a viscosity of 28 cP or less at 40° C. Suitably, said viscosity comprises dynamic viscosity.

The ester composition (I) typically has a pour point of minus 20° C. or less; more typically it has a pour point of minus 30° C. or less; more typically it has a pour point of minus 40° C. or less; still more typically it has a pour point of minus 50° C. or less.

The ester composition (I) typically has a measured pour point of minus 50° C. to minus 62° C., or even lower, when the pour point is measured according to the standard of ISO 3016.

The ester composition of the invention typically has a COC (Cleveland open cup) fire point of 280° C. or higher when measured according to the standard of ISO 2592; more typically it has a COC fire point of 300° C. or higher; still more typically it has a COC fire point of 310° C. or higher. In comparison, the mineral oil currently used in the electrical cables has a fire point of around 170° C. The mineral oil is therefore much more prone to catching fire than ester composition (I).

Typically, the biodegradable fluid comprises the ester composition (I) in an amount of at least 95% by weight of the dielectric fluid composition. Suitably, the dielectric fluid composition comprises the ester composition (I) in an amount of at least 96% by weight of the composition, for example in an amount of at least: 97%, 98% or 99% by weight of the composition. Typically, the dielectric fluid composition comprises the ester composition (I) in an amount of at least 99.5% by weight of the composition.

The biodegradable fluid may comprise minor or trace amounts of unreacted alcohol and/or acids as impurities. Suitably, the dielectric fluid composition is substantially free of alcohol and/or acids.

The biodegradable fluid typically has a viscosity of 35 cP or less when measured using a Brookfield DV-I Prime Viscometer at 40° C.; more typically it has a viscosity of 33 cP or less at 40° C.; more typically it has a viscosity of 30 cP or less at 40° C.; still more typically it has a viscosity of 28 cP or less at 40° C. Suitably, said viscosity comprises dynamic viscosity.

The biodegradable fluid typically has a pour point of minus 20° C. or less; more typically it has a pour point of minus 30° C. or less; more typically it has a pour point of minus 40° C. or less; still more typically it has a pour point of minus 50° C. or less.

The biodegradable fluid typically has a measured pour point of minus 50° C. to minus 62° C., or even lower, when the pour point is measured according to the standard of ISO 3016.

The biodegradable fluid typically has a COC (Cleveland open cup) fire point of 280° C. or higher when measured according to the standard of ISO 2592; more typically it has a COC fire point of 300° C. or higher; still more typically it has a COC fire point of 310° C. or higher. The mineral oil used in existing cables is therefore much more prone to catching fire than ester composition (I). In addition, the ester composition (I) is readily biodegradable and exhibits a greater degree of moisture tolerance than the mineral oil, i.e. it is able to absorb a greater amount of water than mineral oil without compromising its dielectric properties.

According to a further aspect of the invention, the biodegradable fluid comprises one or more ester compositions (II). The one or more ester compositions (II) may comprise a plurality of esters derived from a reaction of:
i) one or more polyols, wherein the one or more polyols are each independently a straight chain or branched C₂-C₈ polyol; and
ii) two or more carboxylic acids, wherein the carboxylic acids are each independently a straight chain or branched C₄-C₁₂ carboxylic acid.

According to one embodiment of the invention, each of the one or more polyols in this embodiment may be a C₂, C₃, C₄, C₅, C₆, C₇, or C₈ polyol. Typically, each of the one or more polyols is selected from straight or branched C₂ to C₅ polyols, and may have a C₂ to C₃ backbone, with or without one or more hydrocarbon side groups. Where any of the polyols are branched, they typically have one or more C₁ or C₂ side groups, typically C₁.

By way of non-limiting examples, the polyol may be selected from neopentyl glycol (NPG), glycerol, butane diol, ethylene glycol and propylene glycol. More typically, only one polyol is used; the polyol is typically NPG.

According to another embodiment of the invention, the two or more carboxylic acids are typically each independently selected from straight chain or branched C₄, C₅, C₆, C₇, C₈, C₉, C₁₀, C₁₁ and C₁₂ carboxylic acids. More typically, the two or more carboxylic acids are typically each independently selected only from straight chain or branched C₇, C₈, C₉, C₁₀, C₁₁ and C₁₂ carboxylic acids and do not include any acids outside of this range. Still more typically, they are each independently selected only from straight chain or branched C₇, C₈, C₉, C₁₀ carboxylic acids, and do not include any acids outside of this range.

According to one embodiment of the invention, the polyol reacts with two or more carboxylic acids, more typically with only two carboxylic acids.

In this embodiment, typically, a first carboxylic acid is a C₇, C₈, or C₉ acid. More typically, it may be a C₈ acid, more typically a branched C₈ acid, such as, for example, 2-ethylhexanoic acid (2EHA).

Typically, the second carboxylic acid is a straight or branched C₈, C₉, or C₁₀ acid, more typically a straight chain C₈, C₉, or C₁₀ acid, i.e. n-octanoic acid, n-nonanoic acid, or n-decanoic acid. More typically, the acid is n-nonanoic acid.

Typically, the ester composition comprises esters formed from the reactions of a polyol with (i) a branched C₈ carboxylic acid as the first carboxylic acid; and (ii) a linear C₉ carboxylic acid as the second carboxylic acid.

According to one embodiment of the invention, the polyol is neopentylglycol (NPG), the first carboxylic acid is 2EHA, and the second carboxylic acid is n-nonanoic acid.

The resulting product from this reaction of one or more polyols and two carboxylic acids is not a pure substance and comprises a mixture of a number of possible ester structures. This ester mixture arises as a natural consequence of the reaction process. For example, NPG contains two alcohol functional groups, so the reaction of NPG with two acids (such as 2EHA, and a C₉ acid) would result in three different di-ester structures, the di-esters containing the functional groups of:

### 2EHA and 2EHA

### 2EHA and C₉

C₉ and C₉.

According to another embodiment, the polyol reacts with three or more carboxylic acids, and typically three carboxylic acids are used.

In this second embodiment, typically, a first carboxylic acid is a C₇, C₈, or C₉ acid. More typically, it may be a C₈ acid, more typically a branched C₈ acid, such as, for example, 2-ethylhexanoic acid (2EHA).

Typically, a second carboxylic acid is a C₈, C₉, or C₁₀ acid, such as, for example, n-octanoic acid, n-decanoic acid, or isononanoic acid (3,5,5-trimethylhexanoic acid). There may also typically be a third carboxylic acid, which may also be a C₈, C₉, or C₁₀ acid, such as, for example, n-octanoic acid, n-decanoic acid, or isononanoic acid, and which is different to the second carboxylic acid.

Typically, the ester composition (II) comprises esters formed from the reactions of a polyol with (i) a branched C₈ carboxylic acid as the first carboxylic acid; (ii) a linear C₈ carboxylic acid and a linear C₁₀ carboxylic acid as the second and third carboxylic acids.

According to one embodiment of the invention, the polyol is neopentaglycol (NPG), the first carboxylic acid is 2EHA, and the second and third carboxylic acids are a mixture of different C₈, C₉, or C₁₀ carboxylic acids. Typically, the second and third carboxylic acids are a mixture of n-octanoic acid (C₈) and decanoic acid (C₁₀).

The resulting product from this reaction of one or more polyols and three carboxylic acids is not a pure substance and comprises a mixture of a number of possible ester structures. This ester mixture arises as a natural consequence of the reaction process. For example, NPG contains two alcohol functional groups, so the reaction of NPG with three acids (such as 2EHA, C₈ acid and a C₁₀ acid) would result in six different di-ester structures, the di-esters containing the functional groups of:

### 2EHA and 2EHA

### 2EHA and C8

### 2EHA and C10

### C8 and C8

### C8 and C10

### C10 and C10.

The ester composition (II) may comprise small amounts of unreacted alcohol and/or acids as impurities. Typically, the ester composition is substantially free of alcohol and/or acids.

The ester composition (II) is suitable for use as a dielectric fluid at extremely low temperatures, such as below about minus 50° C., below about minus 60° C., below about minus 70° C., and even down to about minus 75° C.

Typically, the ester composition (II) has a pour point of minus 50° C. or less when measured according to the method of ISO 3016, more typically minus 55° C. or less, more typically minus 60° C. or less, more typically minus 65° C. or less, or even minus 70° C. or less, when said pour point is measured according to the method of ISO 3016. Typically, the pour point is about minus 75° C., or even less.

Typically, the ester composition (II) has a viscosity of 20 cP or less at 40° C. measured using a Brookfield DV-I Prime Viscometer; more typically of 15 cP or less at 40° C., or of 10 cP or less at 40° C., or of 3-10 cP or less at 40° C. Typically, said viscosity comprises dynamic viscosity.

Typically, the ester composition (II) has a COC Fire point of 200° C. or higher measured according to the method of ISO 2592; more typically 210° C. or higher, or 220° C. or higher. It is therefore more fire safe than mineral oil, which has a fire point of around 170° C. The mineral oil is therefore much more prone to catching fire than ester composition (II). Crucially, these advantages do not compromise the dielectric properties of the ester composition (II). In addition, the ester composition (II) is also readily biodegradable and exhibits a greater degree of moisture tolerance than the mineral oil.

According to another embodiment, the biodegradable fluid may comprise an ester composition which comprises a plurality of esters derived from a reaction of (i) one or more polyols, wherein the one or more polyols are each independently a straight chain or branched C₂-C₈ polyol (and which may include pentaerythritol); and (ii) a combination of n-heptanoic acid and a branched C₉ acid, such as 3,5,5-trimethylhexanoic acid.

According to another embodiment, the biodegradable fluid may comprise an ester composition which comprises a plurality of esters derived from a reaction of (i) one or more polyols, wherein the one or more polyols are each independently a straight chain or branched C₂-C₈ polyol (and which may include pentaerythritol); and (ii) a combination of n-heptanoic acid, n-octanoic acid, a branched C₉ acid, such as 3,5,5-trimethylhexanoic acid, and n-decanoic acid.

According to another embodiment of the invention, the biodegradable fluid consists essentially of either ester composition (I) or ester composition (II), or any other ester composition detailed herein, or any one or more natural esters.

Typically, the biodegradable fluid is substantially free of any additives, and more typically are completely free of additives, such as antioxidants, metal deactivators and pour point depressants, and combinations thereof.

However, according to another embodiment of the invention, the biodegradable fluid may contain one or more additives. If so, the additives are typically selected from antioxidants, metal deactivators and pour point depressants, and combinations thereof.

Typically, the biodegradable fluid may comprise the ester composition (I) or (II) in an amount of at least 95% by weight. Suitably, the biodegradable fluid comprises the ester composition (I) or (II) in an amount of at least 96% by weight of the biodegradable fluid, for example in an amount of at least: 97%, 98% or 99% by weight of the biodegradable fluid. Typically, the biodegradable fluid comprises the ester composition (I) or (II) in an amount of at least 99.5% by weight of the biodegradable fluid.

Typically, the biodegradable fluid may comprise the additives in the following amounts:
one or more antioxidants in a total amount of about 0.0001% to about 1% by weight of the biodegradable fluid; and/or
one or more metal deactivators in a total amount of about 0.0001% to about 1% by weight of the biodegradable fluid; and/or
one or more pour point depressants in a total amount of 0% to about 1% by weight of the biodegradable fluid.

Combinations of any two or more of these additives may be used, as desired.

Typically, the biodegradable fluid comprises an antioxidant in an amount of at least about 0.0001% by weight of the biodegradable fluid, more typically in an amount of at least about 0.001%, at least about 0.01%, at least about 0.1%, at least about 0.25% by weight of the biodegradable fluid, for example in an amount of about 0.25% by weight of the biodegradable fluid.

Suitably, the biodegradable fluid comprises one or more additives selected from antioxidants and metal deactivators.

The biodegradable fluid may be substantially or completely free from pour point depressant. Alternatively, the biodegradable fluid may comprise a pour point depressant.

According to one embodiment of the invention, the biodegradable fluid is dried during its production, and it therefore substantially free of any moisture, and more typically is completely free of any moisture. By ‘substantially free of any moisture’ is meant herein that the biodegradable fluid typically contains about 50 ppm of moisture.

According to another embodiment of the present invention, there is provided the use of a biodegradable fluid as defined hereinabove for the provision of electrical insulation in an electrical cable.

The present invention will now be illustrated by way of the following example, which are intended to be exemplary only, and in no way limiting upon the scope of the invention.

### EXAMPLE 1

An ester composition (I) suitable for use as a dielectric fluid was prepared by forming esters by reacting pentaerythritol with a mixture of n-heptanoic acid (C₇), n-nonanoic acid (C₉), and 2-ethylhexanoic acid. An ester composition was prepared according to the following method:

Pentaerythritol was combined with n-heptanoic acid, n-nonanoic acid, and 2-ethylhexanoic acid. The amounts of acids and alcohols were selected such that the acid mixture was present in a molar excess relative to the alcohol.

Esters were then prepared by refluxing pentaerythritol with the acid mixture at a temperature of over 220° C. under a nitrogen atmosphere for a number of hours to produce an ester composition. Water was removed as it was formed using a Dean-Stark apparatus.

Following completion of the reflux stage, excess acid was removed by vacuum distillation, and the acid value, hydroxyl value and colour of the ester composition were determined. The results are presented in Table 3 below.

The ester composition was then processed further to prepare a dielectric fluid composition.

The ester composition was then stirred under heating for one hour in the presence of Alumina in such an amount as was required to neutralise the reaction mixture to remove any residual acid, as well as Fullers' earth powders to clean the sample, and sterically hindered phenolic antioxidant. The composition was then filtered.

A tolutriazole derivative metal deactivator was added to the composition.

Electrical and physical testing was performed on the composition according to the test methods given in Table 1 below. The results are presented in Table 2.

TABLE 1

| Property | Test Method |
|---|---|
| Water content | IEC 60814 |
| Acid Value | Modified IEC 62021-2 |
| Hydroxyl value | IR spectrometer |
| Colour | ISO 2211 |
| Tan delta at 90° C. | IEC 60247 |
| VR at 90° C. | IEC 60247 |
| Breakdown | IEC 60156 |
| Viscosity at 40° C. | Brookfield DV-I Prime |
| | Viscometer |
| Density at 20° C. | ISO 3675 |
| COC fire point | ISO 2592 |
| PMCC flash point | ISO 2719 |
| Pour point | Modified ISO 3016 |

TABLE 2

| Physical and electrical | Value |
|---|---|
| Water content (ppm) | 50 |
| Acid Value (mgKOH/g) | 0.022 |
| Hydroxyl (mgKOH/g) | 0.5 |
| Colour (HU) | 57 |
| Tan delta at 90° C. | 0.008 |
| VR at 90° C. (GΩm) | 32.6 |
| Breakdown (kV) | 93.5 |
| Viscosity at 40° C. (cP) | 26.4 |
| Density at 20° C. (g/cm³) | 0.973 |
| COC Fire point (° C.) | 312 |
| PMCC Flash point (° C.) | 268 |
| Pour point (° C.) | −56 |

As can be seen from the above, the dielectric composition of Example 1 has physical and electrical properties rendering it entirely suitable for use as a dielectric fluid.

### EXAMPLE 2

This example shows the preparation of an ester composition (II). Neopentyl glycol, 2-Ethylhexanoic acid, and n-nonanoic acid blend were added to a 2-Litre round bottom flask fitted with Dean-Stark apparatus and a condenser. The reaction mixture was stirred under heating for one hour in the presence of alumina to neutralise the reaction mixture, subjected to a purifying powder treatment, and an antioxidant was added. The ester was filtered twice, a metal deactivator was added, and the ester was degassed until the moisture content of the ester was about 50 ppm.

The properties of the ester composition (II) are shown in Table 3 below.

TABLE 3

| Property | Units | Example 2 | Test Method |
|---|---|---|---|
| Water content | ppm | 50 | IEC 60814 |
| Acid Value | mgKOH/g | <0.03 | IEC 62021-2 |
| Colour | HU | 100 | ISO 2211 |
| Tan delta at 90° C. | | <0.03 | IEC 60247 |
| and 50 Hz | | | |
| Volume resistivity | GΩcm | >10 | IEC 60247 |
| DC at 90° C. | | | |
| Breakdown voltage | kV | >75 | IEC 60156 |
| Viscosity at 100° C. | cP | | ISO 3104 |
| Viscosity at 40° C. | cP | | |
| Viscosity at 0° C. | cP | 42.1 | |
| Viscosity at −10° C. | cP | 79.4 | |
| Viscosity at −20° C. | cP | 172 | |
| Viscosity at −30° C. | cP | 434 | |
| Viscosity at −40° C. | mm² s⁻¹ | 1330 | |
| Viscosity at −50° C. | mm² s⁻¹ | 5060 | |
| Density at 20° C. | kg dm⁻³ | 0.92 | ISO 3675 |
| PMCC flash point | ° C. | 190 | ISO 2719 |
| COC fire point | ° C. | 220 | ISO 2592 |
| Pour point | ° C. | −72 | ISO 3016 |
| | | | (modified)/ ISO |
| | | | 3016 |

### EXAMPLE 3

An ester composition (I) suitable for use as a dielectric fluid was prepared by forming esters by reacting pentaerythritol with a mixture of n-heptanoic acid (C₇), n-nonanoic acid (C₉), and 2-ethylhexanoic acid. An ester composition was prepared according to the following method:

Pentaerythritol was combined with n-heptanoic acid, n-nonanoic acid, and 2-ethylhexanoic acid. The amounts of acids and alcohols were selected such that the acid mixture was present in a molar excess relative to the alcohol.

Esters were then prepared by refluxing pentaerythritol with the acid mixture at a temperature of over 220° C. under a nitrogen atmosphere for a number of hours to produce an ester composition. Water was removed as it was formed using a Dean-Stark apparatus.

Following completion of the reflux stage, excess acid was removed by vacuum distillation

The ester composition was then processed further to prepare a dielectric fluid composition.

The ester composition was then stirred under heating for one hour in the presence of Alumina in such an amount as was required to neutralise the reaction mixture to remove any residual acid, as well as Fullers' earth powders to clean the sample. The composition was then filtered.

The composition of Example 3 is essentially the same as that of Example 1, but not including any additives.

As can be seen from the above, the dielectric fluid composition of Example 2 has physical and electrical properties which render it particularly suitable for use and successful operation as a dielectric fluid in electrical apparatuses in extreme low temperatures.

The fluids of Examples 1-3 are all considered to be ‘readily biodegradable’ according to the OECD 301 tests.

It is of course to be understood that the present invention is not intended to be restricted to the foregoing specific embodiments, which are described by way of example only. The invention extends to any novel feature, or combination of features, disclosed in this specification (including any accompanying claims, abstract and drawings), or to any novel one, or any novel combination, of the steps of any method or process so disclosed.

1. An electrical cable comprising a biodegradable fluid as an electrical insulation material.

2. An electrical cable according to claim 1, wherein the biodegradable fluid comprises an ester composition comprising one or more natural or synthetic esters.

3. An electrical cable according to claim 1, wherein the ester composition comprises a plurality of esters derived from a reaction of:
i) one or more polyols, wherein the one or more polyols are each independently a straight chain or branched C₂-C₈ polyol; and
ii) two or more carboxylic acids, wherein the carboxylic acids are each independently a straight chain or branched C₄-C₁₂ carboxylic acid.

4. An electrical cable according to claim 3, wherein the one or more polyols are each independently selected from straight or branched C₂ to C₅ polyols;
wherein the one or more polyols optionally each independently have a C₂ to C₃ backbone and one or more C₁ or C₂ hydrocarbon side groups;
wherein the one or more polyols optionally each independently comprise neopentyl glycol (NPG), glycerol, butane diol, ethylene glycol or propylene glycol, or combinations of any thereof.

5. An electrical cable according to claim 3, wherein only one polyol is used, wherein the polyol optionally comprises neopentyl glycol.

6. An electrical cable according to claim 3, wherein the one or more polyols each react with first, second and third carboxylic acids.

7. An electrical cable according to claim 6, wherein the first carboxylic acid comprises a C₇, C₈, or C₉ acid;
wherein the first carboxylic acid optionally comprises a branched C₈ acid, which is optionally 2-ethylhexanoic acid.

8. An electrical cable according to claim 6, wherein the second and third carboxylic acids are different to each other and are each independently selected from a straight chain or branched C₈, C₉, or C₁₀ acid;
wherein the second and third carboxylic acids are optionally different to each other and are optionally each independently selected from n-octanoic acid, n-decanoic acid, or isononanoic acid (3,5,5-trimethylhexanoic acid).

9. An electrical cable according to claim 3, wherein the one or more polyols comprise neopentaglycol, and the one or more polyols react with first, second and third carboxylic acids, wherein the first carboxylic acid is 2-ethylhexanoic acid, and the second and third carboxylic acids comprise a mixture of two different straight chain or branched C₈, C₉, or C₁₀ carboxylic acids;
optionally wherein the second and third carboxylic acids comprise a mixture of n-octanoic acid and decanoic acid.

10. An electrical cable according to claim 1, wherein the ester composition comprises a plurality of esters derived from a reaction of:
i) one or more polyols, wherein the one or more polyols are each independently a straight chain or branched C₂-C₈ polyol; and
ii) first, second and third carboxylic acids, wherein the first, second and third carboxylic acids are each independently a straight chain or branched C₄-C₁₂ carboxylic acid.

11. An electrical cable according to claim 10, wherein the one or more polyols are each independently selected from straight or branched C₂ to C₆ polyols;
wherein the one or more polyols optionally each independently have a C₂ to C₃ backbone and one or more C₁ or C₂ hydrocarbon side groups;
wherein the one or more polyols optionally comprise pentaerythritol, neopentyl glycol (NPG), glycerol, butane diol, ethylene glycol or propylene glycol, or combinations of any thereof.

12. An electrical cable according to claim 10, wherein only one polyol is used; wherein the polyol optionally comprises pentaerythritol.

13. An electrical cable according to claim 10, wherein the first carboxylic acid comprises a C₇, C₈, or C₉ acid.

14. An electrical cable according to claim 13, wherein the first carboxylic acid comprises a branched C₈ acid, which is optionally 2-ethylhexanoic acid.

15. An electrical cable according to claim 10, wherein the second carboxylic acid is selected from a straight chain or branched C₆, C₇, or C₈ acid.

16. An electrical cable according to claim 15, wherein the second carboxylic acid is a C₇ acid, which is optionally n-heptanoic acid.

17. An electrical cable according to claim 10, wherein the third carboxylic acid is selected from a straight chain or branched C₈, C₉, or C₁₀ acid;
wherein the third carboxylic acid is optionally a C₉ acid, which is optionally n-nonanoic acid.

18. An electrical cable according to claim 10, wherein the one or more polyols comprise pentaerythritol, the first carboxylic acid comprises 2-ethylhexanoic acid, the second carboxylic acid comprises n-heptanoic acid, and the third carboxylic acid comprises n-nonanoic acid.

19. An electrical cable according to claim 1, wherein the biodegradable fluid is substantially free of additives and/or moisture.

20. An electrical cable according to claim 10, wherein the biodegradable fluid is substantially free of additives and/or moisture.
